(19) United States
(12) Patent Application Publication
(10) Pub. No.: US 2026/0129509 A1
(43) Pub. Date: May 7, 2026

(54) METHOD AND APPARATUS FOR BUFFER STATUS REPORT IN NEXT GENERATION MOBILE COMMUNICATION SYSTEM

(71) Applicant: SAMSUNG ELECTRONICS CO., LTD., Suwon-si, Gyeonggi-do (KR)

(72) Inventors: Weiping SUN, Suwon-si (KR); Anil AGIWAL, Suwon-si (KR); Hyunjeong KANG, Suwon-si (KR); Sangkyu BAEK, Suwon-si (KR)

(21) Appl. No.: 19/114,374

(22) PCT Filed: Sep. 12, 2023
(86) PCT No.: PCT/KR2023/013656

§ 371 Date: Mar. 21, 2025

(30) Foreign Application Priority Data
Sep. 26, 2022 (KR) 10-2022-0121772

(51) Int. Cl. H04W 28/02; H04W 72/231

(52) U.S. Cl. CPC H04W 28/0278; H04W 72/231

(57) ABSTRACT

The present disclosure relates to a 5G or 6G communication system for supporting a higher data transmission rate. In addition, the present disclosure relates to a method and apparatus for a BSR of a user equipment in a wireless communication system. The present disclosure relates to a method for a user equipment in a wireless communication system and an apparatus performing same, the method comprising the steps of: receiving, from a base station, control information for reporting delta buffer size information; acquiring the delta buffer size information on the basis of the control information; and transmitting, to the base station, a medium access control control element (MAC CE) including the delta buffer size information, wherein the delta buffer size information is determined on the basis of the buffer size of a logical channel group (LCG) and the reference buffer size.

### TECHNICAL FIELD

The present disclosure relates to the field of communications, and to operations of a terminal and a base station. In particular, the present disclosure relates to a method for reporting a buffer status report (BSR) of a terminal, a method for obtaining a BSR in a base station, and a terminal, base station, and communication system related thereto.

### BACKGROUND ART

5G mobile communication technologies define broad frequency bands to provide higher transmission rates and new services, and can be implemented in “Sub 6 GHz” bands such as 3.5 GHz, and also in “above 6 GHz” bands, which may be referred to as mm Wave bands including 28 GHz and 39 GHz. In addition, the implementation of 6G mobile communication technologies, which may be called a Beyond 5G system, in terahertz bands (e.g., 95 GHz to 3 THz bands) has been considered in order to achieve transmission rates fifty times faster than 5G mobile communication technologies and ultra-low latencies reduced to one-tenth of 5G mobile communication technologies.

In the beginning of 5G mobile communication technologies, in order to support services and to satisfy performance requirements in connection with enhanced Mobile Broadband (eMBB), Ultra-Reliable Low-Latency Communications (URLLC), and massive Machine-Type Communications (mMTC), there had been ongoing standardization regarding Beamforming and massive multi-input multi-output (MIMO) for mitigating radio-wave path loss and increasing radio-wave transmission distances in mmWave, supporting various numerologies (e.g., operating a plurality of subcarrier spacings) for efficiently utilizing mmWave resources and dynamic operation of slot formats, initial access technologies for supporting multi-beam transmission and broadbands, definition and operation of a Bandwidth Part (BWP), new channel coding methods such as a Low Density Parity Check (LDPC) code for large amount of data transmission and a polar code for highly reliable transmission of control information, layer 2 (L2) pre-processing, and Network Slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-To-Everything (V2X) for aiding driving determination by autonomous vehicles based on information regarding locations and states of vehicles transmitted by the vehicles and for enhancing user convenience, New Radio-Unlicensed (NR-U) aimed at system operations conforming to various regulation-related requirements in unlicensed bands, NR UE power saving, Non-Terrestrial Network (NTN), which is UE-satellite direct communication for providing coverage in an area in which communication with terrestrial networks is unavailable, and positioning, etc.

Moreover, there has been ongoing standardization in air interface architecture/protocol regarding technologies such as Industrial Internet Of Things (IIoT) for supporting new services through interworking and convergence with other industries, Integrated Access And Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR), etc., and there also has been ongoing standardization in system architecture/service regarding a 5G baseline architecture (e.g., Service based Architecture or Service based Interface) for combining Network Functions Virtualization (NFV) and Software-Defined Networking (SDN) technologies, and Mobile Edge Computing (MEC) for receiving services based on UE locations, etc.

As such 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, drone communication, and the like.

In addition, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, Artificial Intelligence (AI)-based communication technologies for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

The purpose of the present disclosure is to propose a method for improving communication performance between a terminal and a base station. In addition, the purpose of the present disclosure is to propose a BSR reporting method for a terminal and a BSR acquisition method for a base station.

### Technical Solution

The present disclosure for addressing the above problems includes a method for a terminal in a wireless communication system, the method comprising the steps of: receiving, from a base station, control information for reporting delta buffer size information; acquiring the delta buffer size information on the basis of the control information; and transmitting, to the base station, a medium access control control element (MAC CE) including the delta buffer size information, wherein the delta buffer size information is determined on the basis of the buffer size of a logical channel group (LCG) and the reference buffer size.

In addition, the present disclosure includes a method for a base station in a wireless communication system, the method comprising the steps of: transmitting, to a terminal, control information for reporting delta buffer size information; receiving, from the terminal, a medium access control control element (MAC CE) including delta buffer size information; and determining a buffer size of a logical channel group (LCG) on the basis of the delta buffer size information, wherein the delta buffer size information is determined on the basis of the buffer size of the LCG and a reference buffer size.

In addition, the present disclosure includes a terminal in a wireless communication system, the terminal comprising a transceiver and a controller, wherein the controller is configured to: receive, from a base station, control information for reporting delta buffer size information; acquire the delta buffer size information on the basis of the control information; and transmit, to the base station, a medium access control control element (MAC CE) including the delta buffer size information, wherein the delta buffer size information is determined on the basis of a buffer size of a logical channel group (LCG) and a reference buffer size.

In addition, the present disclosure includes a base station in a wireless communication system, the base station comprising a transceiver and a controller, wherein the controller is configured to: transmit, to a terminal, control information for reporting delta buffer size information; receive, from the terminal, a medium access control control element (MAC CE) including delta buffer size information on the basis of the control information; and determine a buffer size of a logical channel group (LCG) on the basis of the delta buffer size information, wherein the delta buffer size information is determined on the basis of the buffer size of the LCG and a reference buffer size.

The technical problems to be achieved in the embodiments of the present invention are not limited to the technical problems mentioned above, and other technical problems not mentioned will be clearly understood by a person having ordinary skill in the art to which the present invention belongs from the description below.

### Advantageous Effects

According to various embodiments of the present disclosure, a method for improving communication performance between a terminal and a base station can be provided.

In addition, according to various embodiments of the present disclosure, a BSR reporting method for a terminal and a BSR acquisition method for a base station can be provided.

### DESCRIPTION OF DRAWINGS

FIG. 1 is a diagram illustrating a structure of a new radio (NR) system.

FIG. 2 is a diagram illustrating a wireless protocol structure in an NR system.

FIG. 3 is a diagram illustrating a method for a terminal to determine a Buffer Status Report (BSR) format in an NR system.

FIG. 4 is a diagram illustrating a Short BSR/Short Truncated BSR MAC CE (medium access control control element) format of an NR system.

FIG. 5 is a diagram illustrating a Long BSR/Long Truncated BSR MAC CE format of an NR system.

FIG. 6 is a diagram illustrating a Short BSR buffer size report table of an NR system.

FIG. 7 is a diagram illustrating a MAC Subheader format of an NR system.

FIG. 8 is a diagram illustrating a method for reporting a delta buffer size of a terminal, as an embodiment of the present disclosure.

FIG. 9 is a diagram illustrating an example of allocating a new LCID to a newly defined MAC CE, as an embodiment of the present disclosure.

FIG. 10 is a diagram illustrating an example of allocating a new eLCID to a newly defined MAC CE, as an embodiment of the present disclosure.

FIG. 11 is a diagram illustrating an operation of a base station that receives a report of delta buffer size, as an embodiment of the present disclosure.

FIG. 12 is a diagram illustrating step-by-step a procedure performed by a terminal and a base station to report a delta buffer size, as an embodiment of the present disclosure.

FIG. 13 is a diagram illustrating a procedure in which a base station configures control information for a terminal through RRC signaling, as an embodiment of the present disclosure.

FIG. 14 is a diagram illustrating a Long Delta BSR format, as an embodiment of the present disclosure.

FIG. 15 is a diagram illustrating a method for a terminal to select Short Delta BSR or Long Delta BSR, as an embodiment of the present disclosure.

FIG. 16 is a diagram illustrating a configuration of a terminal according to an embodiment of the present disclosure.

FIG. 17 is a diagram illustrating a configuration of a base station according to an embodiment of the present disclosure.

### MODE FOR DISCLOSURE

Hereinafter, preferred embodiments of the present invention will be described in detail with reference to the accompanying drawings. In this case, it should be noted that in the accompanying drawings, the same components are indicated by the same reference numbers as much as possible. In addition, detailed descriptions of well-known functions and configurations that may obscure the gist of the present invention will be omitted.

In describing the embodiments in this specification, descriptions of technical contents that are well known in the technical field to which the present invention pertains and are not directly related to the present invention are omitted. This is to convey the gist of the present invention more clearly without obscuring it by omitting unnecessary explanations.

For the same reason, some components in the attached drawings are exaggerated, omitted, or schematically illustrated. In addition, the size of each component does not entirely reflect the actual size. The same or corresponding components in each drawing are given the same reference numbers.

The advantages and features of the present invention, and the methods for achieving them, will become clear with reference to the embodiments described in detail below together with the accompanying drawings. However, the present invention is not limited to the embodiments disclosed below, but may be implemented in various different forms, and the present embodiments are provided only to make the disclosure of the present invention complete and to fully convey the scope of the invention to those skilled in the art, and the present invention is defined only by the scope of the claims. Like reference numerals refer to like components throughout the specification.

In this case, it will be understood that each block of the processing flow diagrams and combinations of the flow diagrams can be performed by computer program instructions. These computer program instructions can be loaded onto a processor of a general-purpose computer, a special-purpose computer, or other programmable data processing equipment, so that the instructions executed by the processor of the computer or other programmable data processing equipment create a means for performing the functions described in the flow diagram block(s). These computer program instructions can also be stored in a computer-available or computer-readable memory that can be directed to a computer or other programmable data processing equipment to implement the function in a specific manner, so that the instructions stored in the computer-available or computer-readable memory can also produce a manufactured article including an instruction means for performing the functions described in the flow diagram block(s). Since the computer program instructions may be loaded onto a computer or other programmable data processing equipment, a series of operational steps may be performed on the computer or other programmable data processing equipment to produce a computer-executable process, so that the instructions executing the computer or other programmable data processing equipment may also provide steps for performing the functions described in the flowchart block(s).

Additionally, each block may represent a module, segment, or portion of code that contains one or more executable instructions for performing a particular logical function(s). It should also be noted that in some alternative implementations, the functions mentioned in the blocks may occur out of order. For example, two blocks shown in succession may in fact be performed substantially concurrently, or the blocks may sometimes be performed in reverse order, depending on the corresponding functionality.

Here, the term ‘˜unit’ used in the present embodiment means software or hardware components such as FPGA or ASIC, and the ‘˜unit’ performs certain roles. However, the ‘˜unit’ is not limited to software or hardware. The ‘˜unit’ may be configured to be in an addressable storage medium and may be configured to reproduce one or more processors. Accordingly, as an example, the ‘˜unit’ includes components such as software components, object-oriented software components, class components, and task components, and processes, functions, properties, procedures, subroutines, segments of program code, drivers, firmware, microcode, circuits, data, databases, data structures, tables, arrays, and variables. The functions provided in the components and ‘˜units’ may be combined into a smaller number of components and ‘˜units’ or further separated into additional components and ‘˜units’. Furthermore, the components and ‘˜units’ may be implemented to regenerate one or more CPUs within the device or secure multimedia card.

Hereinafter, the base station is an entity that performs resource allocation of the terminal, and may be at least one of a Node B, a Base Station (BS), an eNode B (eNB), a gNode B (gNB), a wireless access unit, a base station controller, or a node on a network. The terminal may include a User Equipment (UE), an Mobile Station (MS), a cellular phone, a smartphone, a computer, or a multimedia system capable of performing a communication function. In addition, the embodiments of the present disclosure may be applied to other communication systems having a similar technical background or channel form to the embodiments of the present disclosure described below. In addition, the embodiments of the present disclosure may be applied to other communication systems through some modifications without significantly departing from the scope of the present disclosure at the discretion of a person having skilled technical knowledge. For example, the 5th generation mobile communication technology (5G, new radio, NR) developed after LTE-A may be included here, and the 5G below may also be a concept that includes existing LTE, LTE-A, and other similar services. In addition, the present disclosure may be applied to other communication systems through some modifications without significantly departing from the scope of the present disclosure, at the discretion of a person having skilled technical knowledge.

In the following description, terms used to identify connected nodes, terms referring to network entities or network functions (NFs), terms referring to messages, terms referring to interfaces between network objects, terms referring to various identification information, etc. are examples for convenience of explanation. Therefore, the present invention is not limited to the terms described below, and other terms referring to objects having equivalent technical meanings may be used.

For convenience of explanation below, some terms and names defined in the 3rd generation partnership project (3GPP) long term evolution (LTE) standard and/or the 3GPP new radio (NR) standard may be used. However, the present invention is not limited to the above terms and names, but may be equally applied to systems conforming to other standards.

In the next-generation/5G wireless communication system, in order to help the base station schedule resources more efficiently, the terminal is required to report the buffer status to the base station. BSR is used to represent the amount of data stored in the buffer of the terminal. According to the NR specification, the terminal selects an interval index from the ranges of data amounts by interval defined by the index in the buffer status report table, which includes the amount of buffer data to be reported, and includes it in the BSR.

However, the buffer status report table defined in the prior art is designed to represent a larger amount of data in a longer interval as the index value increases. As the amount of data stored in the buffer of the terminal increases, a larger index value must be transmitted, and since it corresponds to a data amount in a longer interval, it becomes difficult for the base station to estimate the exact amount of data in the interval, and thus efficient scheduling becomes difficult.

Therefore, the present disclosure proposes a method for reporting more detailed information on the buffer status by comparing the amount of data stored in the buffer of the terminal with a reference value or reference range previously transmitted to the base station or configured by the base station, and reporting the relative difference compared to the corresponding reference, rather than selecting an index of the buffer status report table based on the absolute value.

In the NR system, buffer status reporting is performed by MAC (Medium Access Control) layer signaling between the terminal and the base station. That is, in case that the Buffer Status Report (BSR) is triggered at a specific transmission time, a BSR control element (MAC Control Element, MAC CE) is included in a MAC protocol data unit (PDU) and is transmitted to the base station. In this case, the BSR control element indicates the amount of packets remaining in the transmission buffer of the terminal after the corresponding MAC PDU is configured, in units of Logical Channel Groups (hereinafter, LCG). The base station estimates the amount of data currently remaining in the buffer of the terminal using the BSR received from the terminal. In the NR system, the terminal can manage the data transmission buffer to be transmitted to the base station for each of eight LCGs.

In the present disclosure, a method is proposed in which a terminal can transmit to a base station a relative difference between the amount of data stored in a transmission buffer of the terminal and a specific reference in order to transmit to a base station the amount of data stored in the transmission buffer of the terminal in more detail.

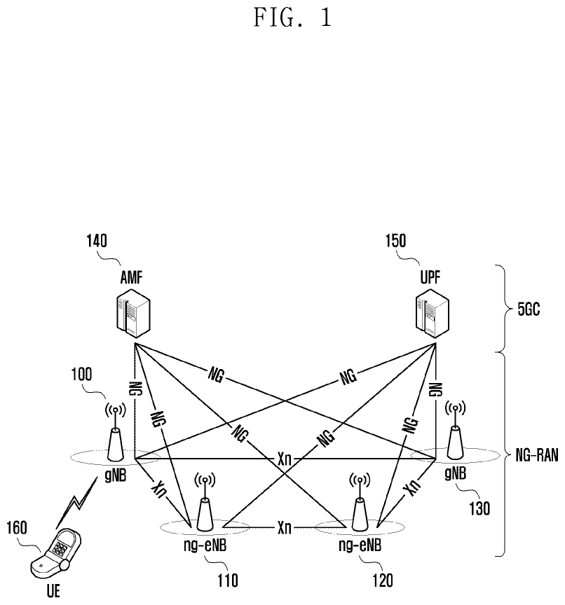

FIG. 1 is a diagram illustrating a structure of an NR system according to an embodiment of the present disclosure.

Referring to FIG. 1, a wireless communication system may be constituted by multiple base stations (e.g., gNB (100), ng-eNB (110), ng-eNB (120), gNB (130)), an Access and Mobility Management Function (AMF) (140) and a User Plane Function (UPF) (150). A user equipment (hereinafter, UE or terminal) (160) may access an external network through the base stations (100, 110, 120, 130) and the UPF (150). In FIG. 1, the base stations (100, 110, 120, 130) may serve as access nodes of a cellular network and provide wireless access to terminals accessing the network. That is, the base stations (100, 110, 120, 130) may collect status information such as buffer status, available transmission power status, and channel status of terminals and perform scheduling to support connection between the terminals and the core network (CN; in particular, the CN of NR is called 5GC) in order to service the traffic of the users. Meanwhile, the user plane (UP) related to transmission of actual user data in communication and the control plane (CP) such as connection management may be configured separately, and in FIG. 1, gNB (100) and gNB (130) use the UP and CP technologies defined in NR technology, and ng-eNB (110) and ng-eNB (120) may use the UP and CP technologies defined in LTE technology even though they are connected to 5GC. The AMF (140) is an entity that is responsible for various control functions as well as mobility management function for the terminal and is connected to a number of base stations, and the UPF (150) may mean a type of gateway entity that provides data transmission. Although not shown in FIG. 1, the NR wireless communication system may include a Session Management Function (SMF). The SMF may manage packet data network connections such as protocol data unit (PDU) sessions provided to the terminal.

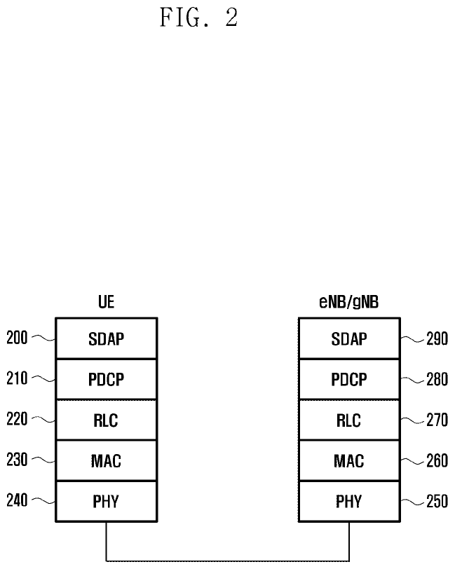

FIG. 2 is a diagram illustrating a wireless protocol structure in an NR/LTE system according to an embodiment of the present disclosure.

Referring to FIG. 2, the wireless protocol of the NR system may be constituted by Service Data Adaptation Protocol (SDAP) (200, 290), Packet Data Convergence Protocol (PDCP) (210, 280), Radio Link Control (RLC) (220, 270), and Medium Access Control (MAC) (230, 260) in the terminal and the base station, respectively.

Service Data Adaptation Protocol (SDAP) (200, 290) performs operations to map each QoS flow to a specific DRB, and the SDAP configuration corresponding to each DRB are given from the upper RRC layer. Packet Data Convergence Protocol (PDCP) (210, 280) is responsible for operations such as IP header compression/restoration, and Radio Link Control (hereinafter, RLC) (220, 270) reconfigures PDCP Protocol Data Unit (PDU) to an appropriate size. MAC (230, 260) is connected to multiple RLC layer entities configured in one terminal, and performs operations to multiplex RLC PDUs into MAC PDUs and demultiplex RLC PDUs from MAC PDUs.

The physical (PHY) layer (240, 250) performs an operation of channel coding and modulating higher layer data into OFDM symbols and transmitting them through a wireless channel, or demodulating and channel decoding OFDM symbols received through a wireless channel and delivering them to a higher layer. In addition, the physical layer also uses HARQ (Hybrid ARQ) for further error correction, where the receiving end transmits 1 bit acknowledgment of receipt of the packet transmitted by the transmitting end. This is called HARQ ACK/NACK information.

Downlink HARQ ACK/NACK information for uplink data transmission is transmitted through a PHICH (Physical Hybrid-ARQ Indicator Channel) physical channel in the case of LTE, and in the case of NR, whether retransmission is necessary or if a new transmission should be performed may be determined through the scheduling information of the corresponding terminal in the PDCCH (Physical Dedicated Control CHannel), which is a channel through which downlink/uplink resource allocation, etc., are transmitted. This is because asynchronous HARQ is adopted in NR. Uplink HARQ ACK/NACK information for downlink data transmission may be transmitted through a PUCCH (Physical Uplink Control Channel) or a PUSCH (Physical Uplink Shared Channel) physical channel. The PUCCH is generally transmitted in the uplink of the PCell, which will be described later, while there is also a case where the base station additionally transmits the PUCCH to the corresponding terminal via a SCell, which will be described later, and this is referred to as PUCCH SCell.

Although not shown in FIG. 2, a Radio Resource Control (RRC) layer exists above the PDCP layer of each terminal and base station, and the RRC layer may exchange connection and measurement-related configuration control messages for radio resource control.

Meanwhile, the PHY layer may be constituted by one or multiple frequencies/carriers, and the technology that configures and uses multiple frequencies simultaneously is called carrier aggregation (hereinafter, CA). By using a primary carrier and one or multiple additional secondary carriers, instead of using only one carrier for communication between a terminal (or User Equipment, UE) and a base station (eNB or gNB), CA technology can dramatically increase the transmission capacity by the number of secondary carriers. Meanwhile, in LTE/NR, a cell within a base station that uses a primary carrier is called a primary cell or PCell (Primary Cell), and a cell within a base station that uses a secondary carrier is called a secondary cell or SCell (Secondary Cell).

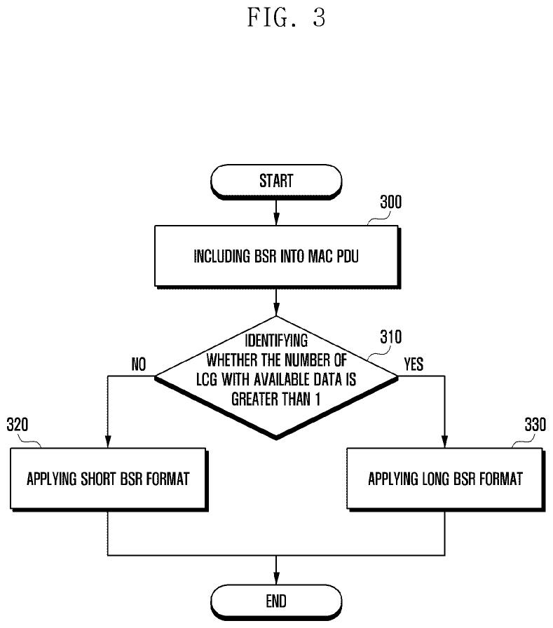

FIG. 3 is a diagram illustrating a method for determining a Buffer Status Report (hereinafter, BSR) format in case that a terminal reports the amount of uplink available data (hereinafter referred to as uplink buffer size), i.e., the uplink buffer size, to a base station in an NR system.

Referring to FIG. 3, in case that a terminal includes a BSR in a MAC PDU and transmits it (300), it selects and transmits one of Long BSR and Short BSR based on the number of Logical Channel Groups (LCGs) with available data, i.e., with the uplink buffer size greater than 0 (310). In this case, if there is more than one LCG with the uplink buffer size greater than 0, Long BSR MAC CE is selected (330), and if there is one LCG, Short BSR MAC CE is selected (320).

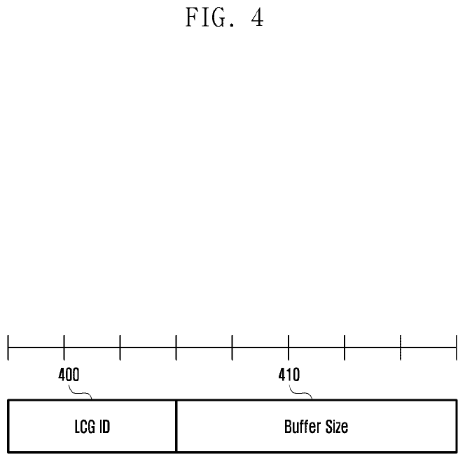

FIG. 4 is a diagram illustrating a Short BSR/Short Truncated BSR MAC CE format defined in an NR system.

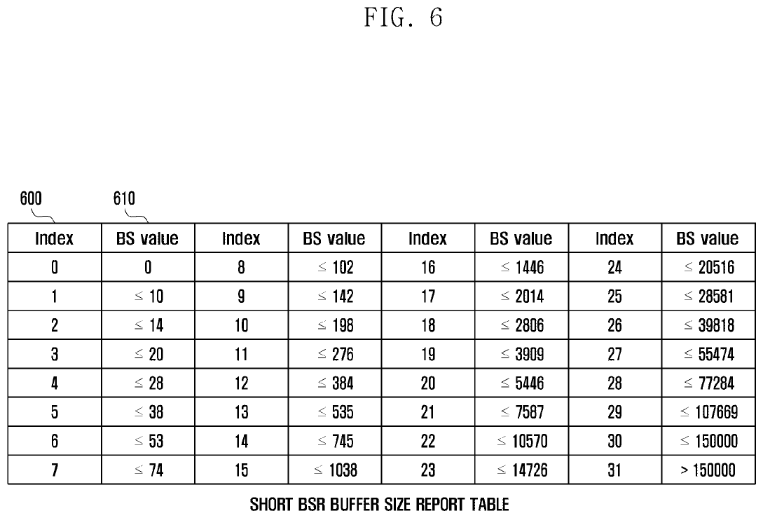

Referring to FIG. 4, Short BSR MAC CE consists of a 3-bit LCG ID (400) field and a 5-bit Buffer Size (410) field. The LCG ID (400) represents an ID (0 to 7) of an LCG, and the Buffer Size (400) field represents a Buffer Size Index (410) determined by an uplink buffer size corresponding to the LCG ID (400). The Buffer Size Index (410) has a value between 0 and 31. The Buffer Size Index (410) represents an index of an interval including an uplink buffer size corresponding to the LCG ID (400) among buffer size intervals defined in a predefined buffer size report table (see FIG. 6).

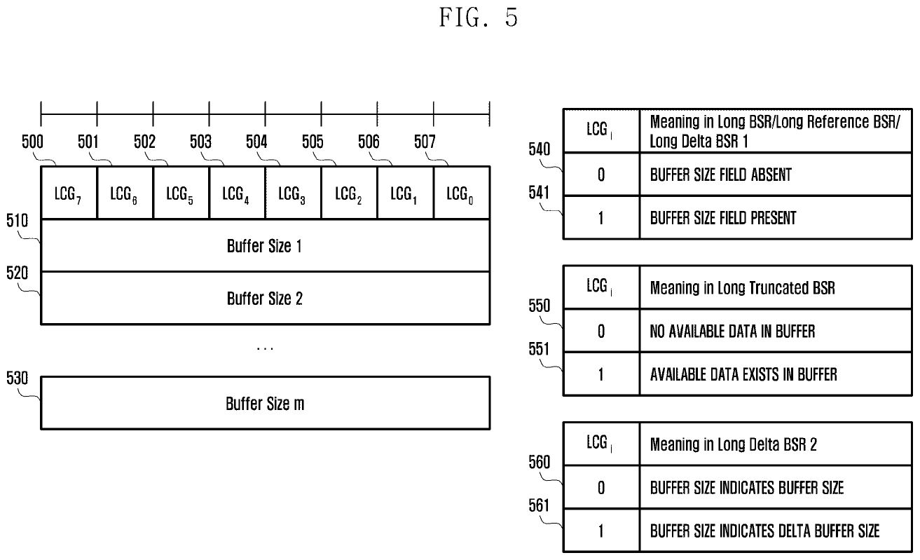

FIG. 5 is a diagram illustrating a Long BSR/Long Truncated BSR MAC CE format defined in an NR system.

Referring to FIG. 5, the Long BSR MAC CE indicates the presence or absence of a Buffer Size field corresponding to each of the eight LCGs from LCG ID 7 (500) to LCG ID 0 (507) in the 8 bits of the first byte. In case that the bit is 0 (540), it means that the Buffer Size field of the LCG corresponding to the bit does not exist in the Long BSR MAC CE. To the contrary, in case that the bit is 1 (541), it means that the Buffer Size field (510, 520, 530) of the LCG corresponding to the bit exists in the Long BSR MAC CE. Accordingly, the Long BSR MAC CE has as many Buffer Size fields (510, 520, 530) as the number of bit Is in the first byte. The length of the Buffer Size field (510, 520, 530) of the Long BSR MAC CE is 8 bits. Long Truncated BSR MAC CE indicates for each of the 8 LCGs from LCG ID 7 (500) to LCG ID 0 (507) whether the uplink buffer size of each LCG is greater than 0 (i.e., whether there is available uplink data) in the 8 bits of the first byte. In case that the bit is 0(550), it means that there is available uplink data in the corresponding LCG, and in case that the bit is 1(551), it means that there is no available uplink data in the corresponding LCG.

In the Long Truncated BSR MAC CE, the number of Buffer Size fields (510, 520, 530) may be represented by the L (750) field of the MAC Subheader that precedes the MAC CE, and the Buffer Size fields (510, 520, 530) are added to the MAC CE as many as the allowed uplink resources in descending order of priority among the LCGs with available data. The Buffer Size field of the Long BSR or Long Truncated BSR, like the Buffer Size field of the Short BSR, also indicates the Buffer Size Index determined by the uplink buffer size. The NR system defines a Long BSR Buffer Size table for the Long BSR, where the Index of the buffer size interval including the uplink buffer size is represented by the Buffer Size field. The length of the Buffer Size (410) of the Short BSR MAC CE is 5 bits, while the length of the Buffer Size field of the Long BSR or Long Truncated BSR MAC CE is 8 bits, which may represent more Buffer Size Indexes. After the base station receives the Buffer Size Index, it refers to the Long BSR Buffer Size report table to obtain information on the uplink buffer size for each LCG.

FIG. 6 is a diagram illustrating a buffer size report table predefined for Short BSR.

The above table defines the BS value (610), i.e., the buffer size interval, corresponding to each of the 32 Indexes (600) expressed as 0 to 31. For example, in case that the Index (600) is 2, it means that the corresponding buffer size has a value between 11 and 14 bytes. After receiving the Short BSR MAC CE, the base station may use the LCG ID (400) and Buffer Size (400) values for uplink resource allocation.

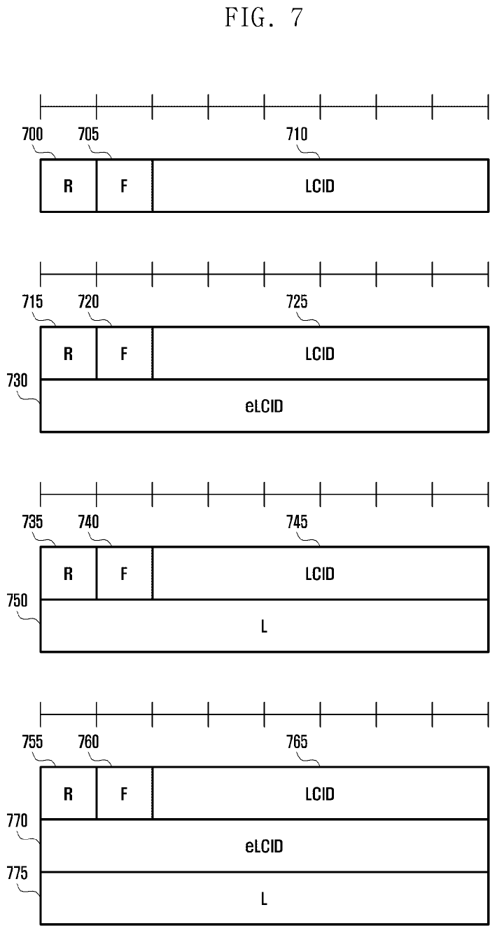

FIG. 7 is a diagram illustrating the format of a MAC Subheader defined in an NR system.

Referring to FIG. 7, a MAC CE having a fixed length may have a 1-Byte MAC Subheader constituted by R (700), F (705), and LCID (710) in front. In this case, the MAC CE may be represented by the LCID (710). A MAC CE having a fixed length may have a 2-Byte MAC Subheader constituted by R (715), F (720), LCID (725), and eLCID (730) in front. In this case, the existence and length of the eLCID (730) may be represented by the LCID (725), and the MAC CE may be represented by the eLCID (730). A MAC CE having a variable length may have a 2-Byte MAC Subheader constituted by R (735), F (740), LCID (745), and L (750) fields in front. In this case, the F (740) may indicate whether the length of the L (750) field is 1 byte or 2 bytes, and the MAC CE may be represented by the LCID (750). A MAC CE having a variable length may be preceded by a 3-byte MAC Subheader constituted by R (755), F (760), LCID (765), eLCID (770), and L (775). In this case, the F (760) may indicate whether the length of the L (775) is 1 byte or 2 bytes, the LCID (765) may indicate the existence and length of the eLCID (770), and the MAC CE may be represented by the eLCID (770). Short BSR/Short Truncated BSR/Long BSR/Long Truncated BSR have different LCID values in the preceding MAC Subheader, so that the base station receiving them may distinguish which format the received BSR is in.

Long BSR/Long Truncated BSR/Short BSR/Short Truncated BSR defined in NR system have the following characteristics.
The Buffer Size Index indicated in the Buffer Size field of the MAC CE does not correspond to a specific buffer size, but rather corresponds to a specific buffer size interval of a predefined table.
The size of the buffer size interval increases as the Buffer Size Index value increases, that is, as the buffer size increases.

Therefore, as the uplink buffer size increases, the terminal will transmit a Buffer Size Index corresponding to a larger buffer size interval, and the base station receiving this may have difficulty in predicting the exact buffer size, making efficient uplink resource allocation challenging.

The present disclosure proposes a method for reporting more detailed buffer size interval than the prior art by comparing a LCG-specific buffer size with a predetermined LCG-specific reference buffer size and reporting the difference value, i.e., a relative buffer size (hereinafter referred to as the Delta buffer size), in case that the terminal reports the LCG-specific buffer size to the base station through BSR.

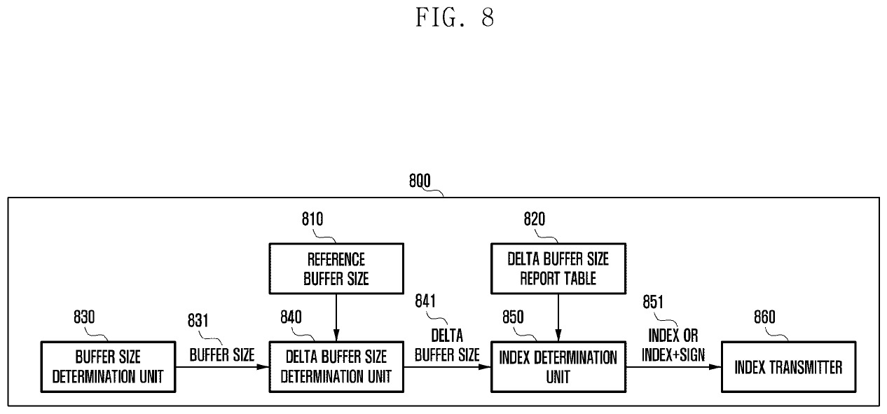

FIG. 8 is a diagram illustrating a method for reporting a delta buffer size of a specific LCG from a terminal (800) perspective according to an embodiment of the present disclosure.

As illustrated in FIG. 8, the terminal (800) may include a buffer size determination unit (830), a reference buffer size (810), a delta buffer size determination unit (840), a delta buffer size report table (820), an index determination unit (850), and an index transmitter (860). Each of the above configurations may be a logical configuration. Therefore, the configuration of the terminal for BSR reporting in the present disclosure is not limited thereto. Some of the above configurations may be combined. In addition, each configuration of FIG. 8 may be referred to as a controller of the terminal, and in this case, an operation performed by each configuration may be described as an operation of the terminal controlller.

The buffer size determination unit (830) is a unit that calculates the uplink buffer size (831) of a specific LCG, i.e., the available uplink data amount of the corresponding LCG. The buffer size determination unit (830) may determine the uplink buffer size (831) of a specific LCG defined in the NR system by referring to the available data amounts of the RLC entity and the PDCP entity corresponding to the corresonding LCG. The method for determining the uplink buffer size (831) may refer to the method specified in the documents TS 38.322 and TS 38.323. The uplink buffer size (831) may be expressed as a natural number.

The delta buffer size determination unit (840) may be notified of the uplink buffer size (831) of the specific LCG determined by the buffer size determination unit (830). The delta buffer size determination unit (840) may compare the uplink buffer size (831) of the LCG with the reference buffer size (810) of the LCG to determine the delta buffer size (841) of the LCG.

The reference buffer size (810) of the LCG may be a natural number including 0, or may be a continuous interval with an upper limit and a lower limit in the form of a natural number.

In case that the reference buffer size (810) of the LCG is a natural number, the delta buffer size (841) of the LCG may be expressed as a relative difference compared to the reference buffer size (810) of the LCG.
For example, it may be set as the delta buffer size (841) of the LCG=the reference buffer size (810) of the LCG-the buffer size (831) of the LCG.
For example, it may be set as the delta buffer size (841) of the LCG=the buffer size (831) of the LCG-the reference buffer size (810) of the LCG.

In case that the reference buffer size (810) of the LCG is expressed in the form of a specific continuous interval, a specific value between the upper limit value and the lower limit value of the reference buffer size (810) of the LCG may be set as the reference value of the reference buffer of the LCG, and the delta buffer size (841) of the LCG can be expressed as a relative difference compared to the reference value of the reference buffer of the LCG. For example, the reference value of the reference buffer of the LCG may be set as the upper limit, the lower limit, or the average value of the upper limit and the lower limit of the reference buffer size of the LCG. In this case, the delta buffer size (841) of the LCG may be set as follows.
For example, it may be set as the delta buffer size (841) of the LCG=the reference value of the reference buffer of the LCG-the buffer size (831) of the LCG.
For example, it may be set as the delta buffer size (841) of the LCG=the buffer size (831) of the LCG-the reference value of the reference buffer of the LCG.

In some cases, the delta buffer size of the LCG is an integer and may be one of a positive number, zero, or a negative number.

The delta buffer size (841) of the LCG may be notified to the index determination unit (850). The index determination unit (850) may determine an index corresponding to the interval to which the delta buffer size (841) of the LCG or the absolute value of the delta buffer size (841) of the LCG belongs by referring to the delta buffer size report table (820), and then may notify the index (851) to the index transmitter (860). The index transmitter (860) may transmit the index (851) to the base station. In addition, the index determination unit (850) may notify the index transmitter (860) of a sign indicating whether the delta buffer size (841) of the LCG is a positive number or negative number, together with the index (851), and the index transmitter (860) may transmit the sign indicating whether the delta buffer size (841) of the LCG is a positive number or negative number, together with the index (851), to the base station. The terminal may include the index and/or the sign in the BSR and transmit it to the base station.

In an embodiment, the delta buffer size report table (820) may be a Short BSR buffer size table or a Long BSR buffer size table defined in the NR system.

In another embodiment, the delta buffer size report table (820) may be a new table that divides a range having a specific lower limit and upper limit into intervals and indicates each interval with a different index. The lower limit value of the new table may be represented as one of a positive number, 0, and a negative number. The upper limit value of the new table may be represented as one of a positive number, 0, and a negative number. The upper limit value may be greater than or equal to the lower limit value.

In yet another embodiment, in case that the reference buffer size (810) of the LCG is represented in the form of a specific continuous interval, the lower limit value of the delta buffer size report table (820) may be set to 0, and the upper limit value may be set to a value obtained by subtracting the lower limit value from the upper limit value of the reference buffer size (810) of the LCG. In this case, the number of different indexes included in the delta buffer size report table (820) may be equal to the number of representable indexes dependent on the number of bits used to report the index corresponding to the delta buffer size to the base station. For example, in case that X bits are used to report the index corresponding to the delta buffer size to the base station, the delta buffer size report table (820) may include 2^{X} indices, wherein the interval between the lower limit value and the upper limit value of the delta buffer size report table (820) is divided into 2^{X} equal intervals and then each index may be allocated to each corresponding interval.

In still another embodiment, the index determination unit (850) may set the absolute value and sign of the value obtained by dividing the delta buffer size (841) by a predefined specific value to the index and sign (851) when determining the index and sign (851).

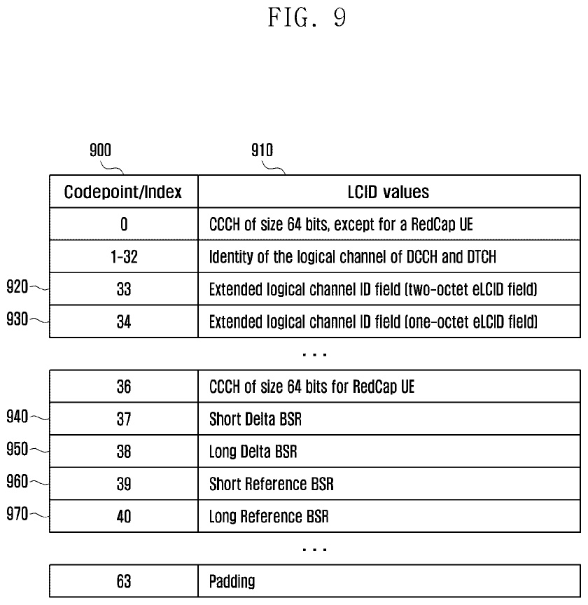

FIG. 9 is a diagram illustrating an example of allocating a new LCID to a newly defined MAC CE, as an embodiment of the present disclosure.

Referring to FIG. 9, among the Codepoints used in the existing NR system, reserved values 37 and 38 may be allocated to indicate Short Delta BSR (940) and Long Delta BSR (950), which are MAC CEs proposed in the present disclosure, respectively. In this case, since Short Delta BSR (940) may have a fixed length, as described in FIG. 7, a MAC Subheader constituted by R (700), F (705), and LCID (710) may be attached, and the LCID (710) may indicate the corresponding Codepoint. Since Long Delta BSR (950) may have a variable length, as described in FIG. 7, a MAC Subheader constituted by R (735), F (740), LCID (745), and L (750) may be attached. In this case, the LCID (745) may indicate the Codepoint of the corresponding MAC CE, and the L (750) may indicate the length of the corresponding MAC CE.

The code point/index (900) column in FIG. 9 defines a code point or index for indicating an LCID value (910). The LCID value (910) column defines an LCID value corresponding to the code point or index.

For example, code point 33 may indicate an extended logical channel ID field (two-octet eLCID field) (920). Code point 34 may indicate an extended logical channel ID field (one-octet eLCID field) (930). Code point 37 may indicate a short delta BSR (940). Code point 38 may indicate a long delta BSR (950). Code point 39 may indicate a short reference BSR (960). Code point 40 may indicate a long reference BSR (970).

The code point value of FIG. 9 is not necessarily limited to the specific value, which is an example and is not limited to the value of FIG. 9. In addition, the characteristic of the present disclosure is that a short delta BSR, a long delta BSR, a short reference BSR, or a long reference BSR is indicated through a specific code point/index.

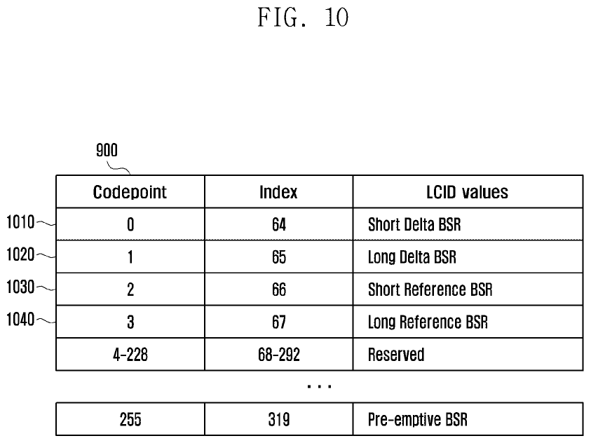

FIG. 10 is a diagram illustrating an example of allocating a new eLCID to a newly defined MAC CE, as an embodiment of the present disclosure.

Referring to FIG. 10, among the eLCID Codepoints used in the existing NR system, the reserved values 0 and 1 may be allocated to indicate Short Delta BSR (1010) and Long Delta BSR (1020), respectively. In this case, since Short Delta BSR (1010) may have a fixed length, a MAC Subheader constituted by R (715), F (720), LCID (725), and eLCID (730) may be attached as described in FIG. 7. In this case, the LCID (725) may indicate the existence and length of eLCID (730), and the eLCID (730) may indicate the Codepoint corresponding to the corresponding MAC CE. Since Long Delta BSR (1020) may be of variable length, a MAC Subheader constituted by R (755), F (760), LCID (765), eLCID (770), and L (775) may be attached as described in FIG. 7. In this case, the eLCID (770) may indicate the Codepoint corresponding to the corresponding MAC CE, and the L (775) may indicate the length of the corresponding MAC CE.

Additionally, the Short Reference BSR and Long Reference BSR MAC CE may be indicated with the Codepoint values 2 (1030) and 3 (1040) of eLCID, respectively.

As shown in FIG. 10, the relationship between code point, index, and LCID may be indicated. Meanwhile, the code point value is not necessarily limited to the index value and LCID information of FIG. 10, which is an example. The characteristic of the present disclosure is that a specific code point matches a specific index, and the specific code point and index indicate an LCID such as a short delta BSR, a long delta BSR, a short reference BSR, or a long reference BSR.

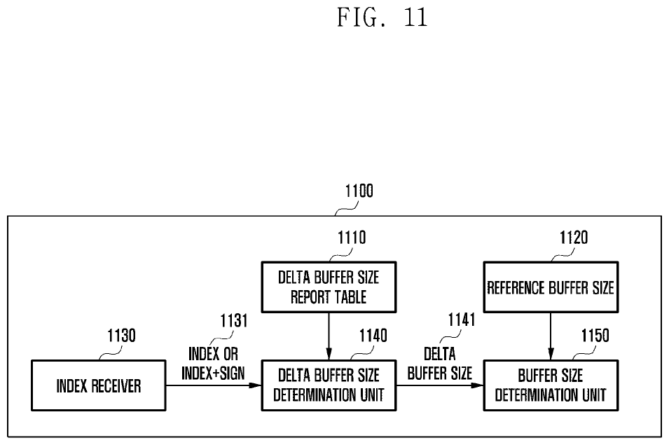

FIG. 11 is a diagram illustrating an operation of a base station (1100) that receives a report of delta buffer size of a specific LCG according to an embodiment of the present disclosure.

As illustrated in FIG. 11, the base station (1100) may include an index receiver (1130), a delta buffer size determination unit (1140), a delta buffer size report table (1110), a reference buffer size (1120), and a buffer size determination unit (1150). Each of the above configurations may be a logical configuration. Therefore, the configuration of the base station receiving the BSR in the present disclosure is not limited thereto. Some of the above configurations may be combined. In addition, each configuration of FIG. 11 may be referred to as a controller of the base station, and in this case, the operation performed by each configuration may be described as an operation of the base station controller.

The index receiver (1130) may receive a delta buffer size index (1131) of a specific LCG from a terminal and then notify the delta buffer size determination unit (1140). The index receiver (1130) may receive a sign indicating whether the delta buffer size of the LCG is a positive number or a negative number from the terminal and notify the delta buffer size determination unit (1140) of the sign together with the index (1131).

The delta buffer size determination unit (1140) may set an interval corresponding to a delta buffer size index (1131) of the LCG as the delta buffer size (1141) of the LCG by referring to the delta buffer size report table (1110). The delta buffer size determination unit (1140) may determine the delta buffer size (1141) of the LCG by using a sign indicating whether the delta buffer size (1141) of the LCG is a positive number or a negative number together with the index (1131). The delta buffer size (1141) of the LCG determined by the delta buffer size determination unit (1140) may be expressed as an interval having a lower limit and an upper limit in the form of a natural number.

The delta buffer size report table (1110) of the base station (1100) may be the same table as the delta buffer size report table (820) of the aforementioned terminal. That is, the terminal and the base station (1100) may refer to the same predefined delta buffer size report table defined.

The reference buffer size (1120) of the base station (1100) may be the same value as the aforementioned reference buffer size (810) of the terminal in FIG. 8. That is, the terminal and the base station (1100) may be in a state of synchronization with respect to the reference buffer size (1120) by exchanging information about the reference buffer size (1120) of a specific LCG in advance.

The buffer size determination unit (1150) may derive the buffer size of the LCG by comparing the delta buffer size (1141) of the LCG with the reference buffer size (1120) of the LCG. The method for deriving the buffer size of the LCG depends on the aforementioned delta buffer size (841) determination method of the delta buffer size determination unit (840) of the terminal of FIG. 8, and the specific derivation method may vary depending on the implementation of the base station.

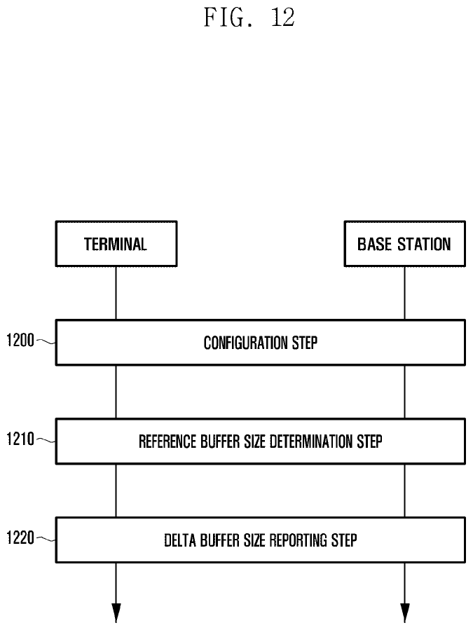

FIG. 12 is a diagram illustrating step-by-step a procedure performed by a terminal (800) and a base station (1100) to report a delta buffer size for a specific LCG according to an embodiment of the present disclosure.

As illustrated in FIG. 12, the terminal and the base station may perform a configuration step (1200), a reference buffer size determination step (1210), and a delta buffer size reporting step (1220) for a specific LCG.

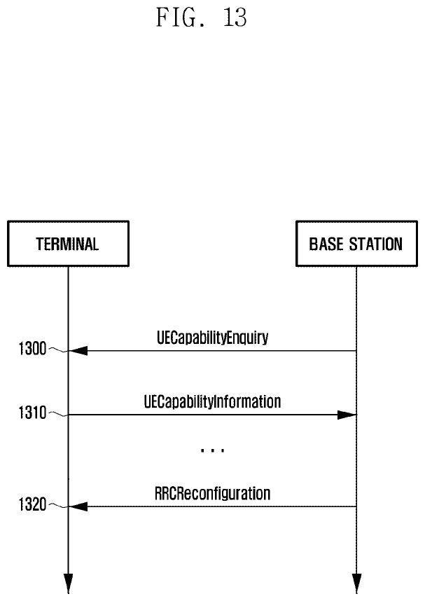

The configuration step (1200) is a step where the base station configures the terminal with control information required for performing delta buffer size reporting. The control information may be configured through RRC signaling or higher layer signaling. In addition, information configured through RRC signaling or higher layer signaling may be configured through a process in which it is activated through a MAC message or downlink control information (DCI). For an example of configuring control information, refer to the contents of FIG. 13 below.

The reference buffer size determination step (1210) is a procedure performed for the terminal and the base station to synchronize the reference buffer size.

In an embodiment, the reference buffer size determination step (1210) may be performed through Short BSR/Short Truncated BSR/Long BSR/Long Truncated BSR transmission of the terminal.

For example, in case that the Buffer Size field of a specific LCG is included in the Buffer Size field of the Short BSR/Short Truncated BSR/Long BSR/Long Truncated BSR, the terminal and the base station may set the reference buffer size of the LCG to the buffer size interval indicated by the Buffer Size field of the LCG.

Additionally, in case that the Buffer Size field of a specific LCG is not included in the Buffer Size field of the Short BSR/Short Truncated BSR/Long BSR/Long Truncated BSR, the terminal and the base station may not modify the reference buffer size of the LCG.

Additionally, in case that the Buffer Size field of a specific LCG is not included in the Buffer Size field of the Short BSR/Short Truncated BSR/Long BSR/Long Truncated BSR, the terminal and the base station may set the reference buffer size of the LCG to 0.

In addition, in case that the Buffer Size field of a specific LCG is included in the Buffer Size field of Long Delta BSR, and the Buffer Size field indicates the uplink buffer size of the LCG, the terminal and the base station may set the reference buffer size of the LCG to the buffer size interval indicated by the Buffer Size field of the LCG.

Additionally, in case that the Buffer Size field of a specific LCG is not included in the Buffer Size field of the Long Delta BSR, the terminal and base station may not modify the reference buffer size of the LCG.

Additionally, in case that the Buffer Size field of a specific LCG is not included in the Buffer Size field of the Long Delta BSR, the terminal and base station may set the reference buffer size of the LCG to 0.

In another embodiment, for the reference buffer size determination step (1210), the reference buffer size synchronization may be performed by defining new MAC CEs and having the terminal transmit the newly defined MAC CE to the base station or the base station transmit the newly defined MAC CE to the terminal.

In one embodiment, the terminal may independently determine the reference buffer size of a specific LCG and transmit the newly defined Short Reference BSR MAC CE to the base station (1100) including the LCG ID and a Buffer Size field indicating the reference buffer size. In this case, the terminal and the base station may set the reference buffer size of the LCG included in the Short Reference BSR to the reference buffer size indicated by the Buffer Size field included in the Short Reference BSR. In another embodiment, the base station may determine the reference buffer size of a specific LCG and transmit the Short Reference BSR to the terminal including the LCG ID and the Buffer Size field indicating the reference buffer size of the LCG. In this case, the terminal and the base station may set the reference buffer size of the LCG included in the Short Reference BSR to the reference buffer size indicated by the Buffer Size field included in the Short Reference BSR.

In one embodiment, the format of the Short Reference BSR MAC CE may be the same as the Short BSR/Short Truncated BSR MAC CE format of FIG. 4. After the terminal or base station transmits or receives the Short Reference BSR MAC CE, the terminal or base station may set the reference buffer size of the LCG corresponding to the LCG ID (400) of the Short Reference BSR MAC CE of FIG. 4 to the buffer size indicated by the Buffer Size (410) field of the Short Reference BSR MAC CE.

In one embodiment, the terminal may determine the reference buffer size of one or more LCGs, and transmit the newly defined Long Reference BSR MAC CE to the base station by adding ID information of the LCGs and a Buffer Size field indicating the reference buffer size for each LCG. In another embodiment, the base station may determine the reference buffer size of one or more LCGs, and transmit the newly defined Long Reference BSR MAC CE to the terminal by adding ID information of the LCGs and a Buffer Size field indicating the reference buffer size for each LCG.

In one embodiment, the format of the Long Reference BSR MAC CE may be the same as the Long BSR/Long Truncated BSR MAC CE format of FIG. 5. After the terminal or base station transmits or receives the Long Reference BSR MAC CE, the terminal or base station may set the reference buffer size for each LCG set to 1 among the LCGi fields (500 to 507) of the Long Reference BSR MAC CE of FIG. 5 to the buffer size indicated by the Buffer Size field of the Long Reference BSR MAC CE.

In one embodiment, the LCID or eLCID indicating the Short Reference BSR/Long Reference BSR may be newly allocated so that the receiving side (terminal) or base station to recognize the Short Reference BSR/Long Reference BSR. For example, as illustrated in FIG. 9, the Short Reference BSR and Long Reference BSR MAC CE may be indicated with LCID Codepoint (900) values 39 (960) and 40 (970), respectively. In addition, as illustrated in FIG. 10, the Short Reference BSR and Long Reference BSR MAC CE may be indicated with eLCID Codepoint values 2 (1030) and 3 (1040), respectively. It should be noted that the Codepoint values illustrated in FIGS. 9 and 10 are merely examples and are not intended to be limiting, and that other appropriate Codepoint values may also be adopted.

In case that the base station has configured the terminal with an LCG list that may use delta buffer size report in the configuration step, the reference buffer size determination step (1210) may occur only for the LCG included in the LCG list.

In case that the base station has configured the terminal with deltaBsrBsThreshold in the configuration step, the reference buffer size determination step (1210) may occur only in case that the uplink buffer size of the corresponding LCG satisfies the delta buffer report allowance criterion defined in advance based on the deltaBsrBsThreshold. For example, in case that the uplink buffer size of the LCG is larger than the deltaBsrBsThreshold corresponding to the LCG, the reference buffer size of the LCG may be modified.

The Buffer Size field of the Short Reference BSR/Long Reference BSR is used to indicate the reference buffer size of a specific LCG in the terminal and base station.
In an embodiment, the Buffer Size field may indicate an index of a Short BSR buffer size report table or a Long BSR buffer size report table. In this case, a buffer size interval of the Short BSR buffer size report table or the Long BSR buffer size report table which corresponds to the index indicated by the Buffer Size field may be interpreted as the reference buffer size.
In an embodiment, a newly defined Short Reference BSR report table or Long Reference BSR report table may be defined, which has specific lower and upper limits and different indices for each buffer size interval. In this case, the Buffer Size field of the Short Reference BSR/Long Reference BSR may indicate an index value of the newly defined Short Reference BSR report table or Long Reference BSR report table. In this case, the buffer size interval corresponding to the index value in the newly defined table may be interpreted as the reference buffer size.
In an embodiment, the Buffer Size field of the Short Reference BSR or Long Reference BSR MAC CE may indicate a specific natural number, and the reference buffer size may be interpreted as a result value of multiplying the natural number by a specific predefined reference value. For example, in case that the value of the Buffer Size field of the Short Reference BSR MAC CE is K, the reference buffer size of the corresponding LCG may be interpreted by multiplying it by a predefined reference value Y, i.e., K×Y. The reference value may be notified to the terminal (800) by the base station (1100) through RRC signaling, or may be a fixed value. The reference value may be defined for each LCG, or may be shared by all LCGs. The reference value may be determined by the length of the Buffer Size field of the Short Reference BSR or the Long Reference BSR MAC CE. The reference value may be a natural number including 0.

In operation 1220, the terminal may report the delta buffer size to the base station. The base station may receive information about the delta buffer size from the terminal.

In an embodiment of the present disclosure, a terminal may define a new MAC CE to report a delta buffer size to a base station.
In an embodiment of the present disclosure, a new Short Delta BSR MAC CE having the same format as the Short BSR/Short Truncated BSR/Short Reference BSR illustrated in FIG. 4 may be defined. Referring to FIG. 4, the Short Delta BSR MAC CE may be constituted by an LCG ID (400) and a Buffer Size (410) field. In this case, the LCG ID (400) may indicate an LCG corresponding to the reported delta buffer size. In an embodiment, the Buffer Size (410) field may indicate an index or an index and a sign (851) indicating the delta buffer size (841) of the LCG. For example, a sign indicating a negative/positive number may be indicated with a specific bit of the Buffer Size (410) field, and the index may be indicated with the remaining bits of the Buffer Size (410) field except for the sign bit. In the example of FIG. 4, the lengths of the LCG ID (400) and Buffer Size (410) fields are shown as 3-bit and 5-bit, but this is only an example and is not intended to be limiting, and it is obvious that other field lengths may also be adopted.
In an embodiment of the present disclosure, a new Long Delta BSR MAC CE having the same format as Long BSR/Long Truncated BSR/Long Reference BSR illustrated in FIG. 5 may be defined. Referring to FIG. 5, the 8 bits of the first byte in the Long Delta BSR MAC CE May Correspond to LCG ID 7 to LCG ID 0, respectively.
The meaning of the bit corresponding to an LCG for which enabledDeltaBSR is not configured may be the same as the meaning of the corresponding field of the Long BSR/Long Truncated BSR of the prior art.
In an embodiment for an LCG with enabledDeltaBSR configured, the presence or absence of the Buffer Size field of the LCG may indicated with the bit corresponding to the LCG. For example, in case that the bit is 0 (540), it may indicate that the Buffer Size field of the corresponding LCG does not exist, and in case that the bit is 1(541), it may indicate that the Buffer Size field exists. In this case, the Buffer Size field corresponding to the LCG with enabledDeltaBSR configured present in the Long Delta MAC CE always indicates the delta buffer size of the LCG. The advantage of this embodiment is that the MAC signaling overhead can be reduced by not adding the Buffer Size field of the LCG in case that the buffer size of a specific LCG is 0. Hereinafter, this embodiment is referred to as Long Delta BSR 1.
In another embodiment for an LCG with enabledDeltaBSR configured, the bit corresponding to the LCG may be used to distinguish whether the Buffer Size field of the LCG indicates the delta buffer size or the buffer size of the LCG. For example, in case that the bit is 0 (560), the Buffer Size field of the corresponding LCG indicates the buffer size, and in case that the bit is 1(561), the Buffer Size field of the corresponding LCG indicates the delta buffer size. In this case, the Buffer Size fields corresponding to all LCGs with enabledDeltaBSR configured shall always be included in the Long Delta BSR MAC CE. The advantage of this embodiment is that it is possible to select whether to report the buffer size or the delta buffer size independently for each LCG with enabledDeltaBSR configured. Hereinafter, this embodiment is referred to as Long Delta BSR 2.
In case that the Buffer Size (510, 520, 530) field of the Long Delta BSR MAC CE indicates the delta buffer size of the corresponding LCG, the Buffer Size field may indicate an index or an index and a sign (851) indicating the delta buffer size. For example, a sign indicating whether the delta buffer size is a negative number or positive number may be indicated with a specific bit of the Buffer Size field, and the index may be indicated by the remaining bits of the Buffer Size field except for the sign bit. In the example of FIG. 5, the length of the Buffer Size field is shown as 8 bits, but this is only an example and is not intended to be limiting, and it is obvious that other field lengths can also be adopted.

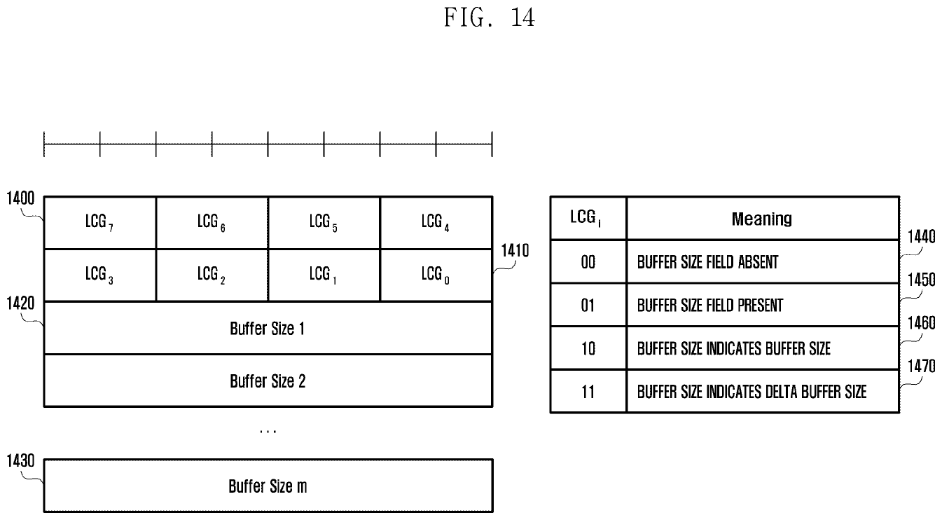

An example of Long Delta BSR MAC CE in this disclosure may refer to the description of FIG. 14.

In the embodiment of FIG. 12, the MAC CE for the operation 1210 and the MAC CE for the operation 1220 may be transmitted in one uplink transport block (TB), or the TB including the MAC CE for the operation 1220 may be transmitted after the TB including the MAC CE for the operation 1210 is transmitted.

Meanwhile, although operations 1210 and 1220 are described separately in the embodiment of FIG. 12, the reference buffer size in the operation 1210 and the delta buffer size in the operation 1220 may also be reported through one message (e.g., one MAC CE). In this case, a new MAC CE indicating the reference buffer and delta buffer sizes for each LCG may be defined.

FIG. 13 is a diagram illustrating an example of the configuration step (1200) of FIG. 12, which is a procedure in which the base station configures control information for the terminal through RRC signaling.

Referring to FIG. 13, a base station may deliver a terminal capability request (UECapabilityEnquiry) message (1300) requesting a capability report to a terminal in a connected state. The base station may include a terminal capability request for each RAT (radio access technology) type in the UECapabilityEnquiry message (1300). The request for each RAT type may include information on the requested frequency band. In addition, in case that the base station requests the terminal to generate a UECapabilityInformation message (1310) through the capability request message (1300), the base station may include filtering information that may indicate conditions and restrictions. In this case, through the filtering information, the base station may indicate whether the terminal should report whether it supports the delta buffer size reporting function. The terminal may constitute a terminal capability information (UECapabilityInformation) message (1310) corresponding to the UECapabilityEnquiry message (1300) and report a response to the request to the base station (1100). In this case, the UECapabilityInformation message (1310) may include a parameter indicating whether the terminal supports the delta buffer size reporting function. For example, the parameter may be 1-bit information. In addition, for example, in case that the parameter is included, it may indicate that the delta buffer size reporting function is supported, and in case that the parameter is not included, it may indicate that the delta buffer size reporting function is not supported. The base station may determine whether the terminal supports the delta buffer size reporting function based on the received UECapabilityInformation message. In case that the base station determines that the terminal supports the delta buffer size reporting function, it may indicate through an RRCReconfiguration message such that the terminal may perform delta buffer size reporting in case that a certain condition is satisfied for a specific LCG. More specifically, to configure delta buffer size reporting related operation, the RRCReconfiguration message may include at least one of the following configuration information.
LCG list that can use delta buffer size reporting: The base station may deliver the LCGs that can perform delta buffer size reporting to the terminal (800) in the form of a list. For convenience, LCG included in the list are expressed as LCG with enabledDeltaBSR configured. In case that the list is included in the configuration information, LCGs that are not included in the list are configured not to perform delta buffer size reporting. The LCG with enabledDeltaBSR configured may have the reference buffer size as a parameter value. The reference buffer size of the LCG with enabledDeltaBSR configured may have an initial value of 0. The base station may configure an initial value through RRC signaling for the reference buffer size of the LCG with enabledDeltaBSR configured.
deltaBsrTimer: The base station may configure the terminal a timer that allows the terminal to report the delta buffer size. In one embodiment, in case that the deltaBsrTimer is configured, the terminal (800) may be configured such that the delta buffer size report is allowed only in case that the deltaBsrTimer is in the Running state. The deltaBsrTimer may be configured and operated for each terminal, each cell group, each LCG, or each cell.
maxDeltaBsrCounter: The base station may configure the terminal with maxDeltaBsrCounter to limit the number of consecutive reports of delta buffer size reporting. The maxDeltaBsrCounter may mean the maximum number of consecutive delta buffer size reports that the terminal can transmit. The maxDeltaBsrCounter may be configured and stored for each terminal, each cell group, each LCG, or each cell. In case that the maxDeltaBsrCounter is configured, the deltaBsrCounter may be configured for each unit in which the maxDeltaBsrCounter of the terminal is configured. The deltaBsrCounter may have an initial value of 0.
deltaBsrBsThreshold: deltaBsrBsThreshold may represent a natural number or a specific range having a lower limit and an upper limit in the form of a natural number. In case that the deltaBsrBsThreshold is a natural number, the base station may configure the terminal such that the delta buffer size reporting can be performed only in case that the uplink buffer size is larger than or smaller than the deltaBsrBsThreshold. In case that the deltaBsrBsThreshold represents a specific range, the base station may configure the terminal such that the delta buffer size reporting can be performed only in case that the uplink buffer size falls within the range represented by the deltaBsrBsThreshold. The deltaBsrBsThreshold may be configured and stored for each terminal, each cell group of terminal, each LCG of terminal, or each cell of terminal.

FIG. 14 is a diagram illustrating a Long Delta BSR format, as an embodiment of the present disclosure.

Referring to FIG. 14, as an example of the present disclosure, a Long Delta BSR MAC CE having a new format may be newly defined. By allocating 2 bits to each of 8 LCGs with the first byte and the second byte of the Long Delta BSR MAC CE, four states may be indicated for each LCG for LCG ID 7 (1400) to LCG ID 0 (1410). For example, in case that the 2 bits of a specific LCG are 00(1440), it may indicate that the Buffer Size field of the LCG is absent in the Long Delta BSR MAC CE. For example, in case that the 2 bits are 01(1450), it may indicate that the Buffer Size field of the LCG is present in the Long Delta BSR MAC CE. For example, in case that the 2-bit of the LCG is 10(1460 ), it may indicate that the Buffer Size field of the LCG is present in the Long Delta BSR MAC CE, and the Buffer Size field indicates the buffer size of the LCG. In case that the 2-bit of the LCG is 11 (1470), it may indicate that the Buffer Size field of the LCG is present in the Long Delta BSR MAC CE, and the Buffer Size field indicates the delta buffer size of the LCG. This example does not limit the correspondence between a specific value of the 2-bit and a specific state among the four states, which is an example, and it is obvious that other correspondences are also possible. The advantage of this embodiment is that the corresponding Buffer Size field may or may not be included depending on the presence or absence of available data for each LCG. In addition, it may be selected for each LCG with enabledDeltaBSR configured whether to indicate the buffer size or the delta buffer size with the Buffer Size field. In case that the Buffer Size (1420, 1430) field of the Long Delta BSR MAC CE indicates the delta buffer size of the corresponding LCG, the Buffer Size field may indicate an index or an index and a sign (851) indicating the delta buffer size. For example, a sign indicating whether the delta buffer size is a negative number or positive number may be indicated with a specific bit of the Buffer Size field, and the index may be indicated by the remaining bits of the Buffer Size field except for the sign bit. In the example of FIG. 14, the length of the Buffer Size field is shown as 8 bits, but this is only an example and is not intended to be limiting, and it is obvious that other field lengths may also be adopted. Hereinafter, the present embodiment is referred to as Long Delta BSR 3.

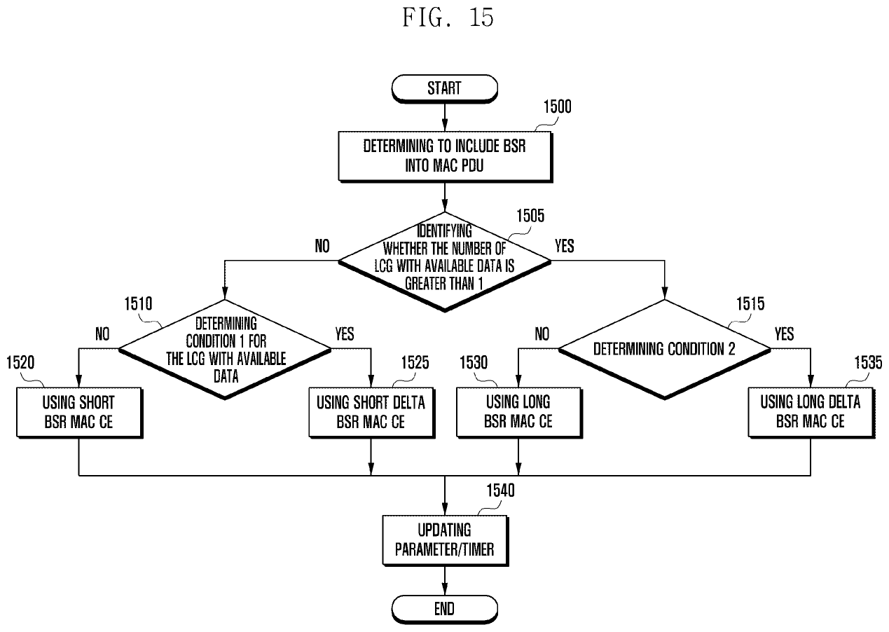

FIG. 15 is a diagram illustrating a method for a terminal to report a delta buffer size according to an embodiment of the present disclosure.

Referring to FIG. 15, a terminal may determine to include a BSR in a MAC PDU at a step of configuring a MAC PDU (1500). In case that the terminal determines to include the BSR in the MAC PDU, it may identify whether the number of LCGs with available data among the LCGs of the terminal is greater than 1(1505). In case that the number of LCGs is 1, the terminal may identify whether condition 1 is satisfied for the LCGs with available data (1510). In case that condition 1 is satisfied, the terminal may apply the Short Delta BSR MAC CE format to the BSR (1525). In case that condition 1 is not satisfied, the Short BSR MAC CE format may be applied to the BSR (1520).

In one embodiment, the condition 1 may include the following condition 1-1. In another embodiment, condition 1 may be a combination of condition 1-1 among the following conditions, and at least one of the other conditions.
Condition 1-1: In case that the base station has configured the terminal with an LCG List with enabledDeltaBSR configured, the LCG shall have enabledDeltaBSR configured.
Condition 1-2: The reference buffer size of the LCG is greater than 0.
Condition 1-3: In case that the reference buffer size of the LCG indicates a specific range having lower and upper limits in the form of natural numbers, the uplink buffer size of the LCG is within the range indicated by the reference buffer size of the LCG.
Condition 1-4: In case that the base station has configured the terminal with the deltaBsrBsThreshold, the uplink buffer size of the LCG satisfies the delta buffer reporting allowance criterion defined in advance based on the deltaBsrBsThreshold. For example, in case that the uplink buffer size of the LCG is larger than the deltaBsrBsThreshold corresponding to the LCG, the delta buffer size reporting of the LCG may be allowed.
Condition 1-5: In case that the base station has configured the terminal with the deltaBsrTimer, the delta buffer reporting allowance criterion defined in advance is satisfied based on the state of the deltaBsrTimer. For example, the delta buffer size reporting of the LCG may be allowed only in case that the deltaBsrTimer corresponding to the LCG is in the Running state. In another embodiment, the delta buffer size reporting of the LCG may be allowed only in case that the deltaBsrTimer corresponding to the terminal, the cell to which the MAC PDU is transmitted, or the cell group to which the MAC PDU is transmitted is in the Running state.

-Condition 1-6: In case that the base station has configured the terminal with the maxDeltaBsrCounter, the delta buffer reporting allowance criterion is satisfied based on the maxDeltaBsrCounter. For example, in case that the deltaBsrCounter corresponding to the terminal, or the LCG, or the cell group to which the MAC PDU is transmitted, or the cell to which the MAC PDU is transmitted is less than or equal to the maxDeltaBsrCounter, the delta buffer size reporting of the LCG may be allowed.

Referring to FIG. 15, in case that the number of LCGs with available data is greater than 1, the terminal may determine whether condition 2 is satisfied (1515). In case that condition 2 is satisfied, the terminal may apply the Long Delta BSR MAC CE format as the BSR format (1535). If condition 2 is not satisfied, the terminal may apply the Long BSR MAC CE format as the BSR format (1530).

In case that the Long Delta BSR MAC CE is the Long Delta BSR 1, the condition 2 may be as follows.
Among the LCGs with available data, there is at least one LCG that satisfies condition 1-1, and all LCGs that satisfy condition 1-1 also satisfy condition 1.

In case that the Long Delta BSR MAC CE is the Long Delta BSR 2 or the Long Delta BSR 3, the condition 2 may be as follows.
Among the LCGs with available data, there is at least one LCG that satisfies condition 1-1, and among the LCGs that satisfy condition 1-1, at least one LCG satisfies condition 1.

Referring to FIG. 15, in one embodiment, in case that the BSR format transmitted by the terminal is Short BSR MAC CE or Long BSR MAC CE, the deltaBsrTimer may be started or restarted. In one embodiment, in case that the BSR format transmitted by the terminal is Short BSR MAC CE or Long BSR MAC CE, the deltaBsrCounter may be initialized to 0.

Referring to FIG. 15, in one embodiment, in case that the BSR format transmitted by the terminal is Short Delta BSR MAC CE or Long Delta BSR MAC CE, the deltaBsrCounter may be increased by 1.

Referring to FIG. 15, in one embodiment, in case that the terminal has reported an uplink buffer size for an LCG satisfying condition 1-1 in the transmitted BSR, the terminal may set the reference buffer size of the LCG to the reported uplink buffer size.

FIG. 15 is an embodiment for the case where the triggered BSR is Regular BSR or Periodic BSR, but the format of Short Delta BSR or Long Delta BSR MAC CE proposed in the present disclosure may also be applied to Padding BSR. In one embodiment, in case that Padding BSR is transmitted with Short BSR MAC CE, if the reported LCG satisfies condition 1, Short Delta BSR MAC CE may be used instead. Also, in case that Padding BSR is transmitted with Long BSR MAC CE, if condition 2 is satisfied, Long Delta BSR may be used instead.

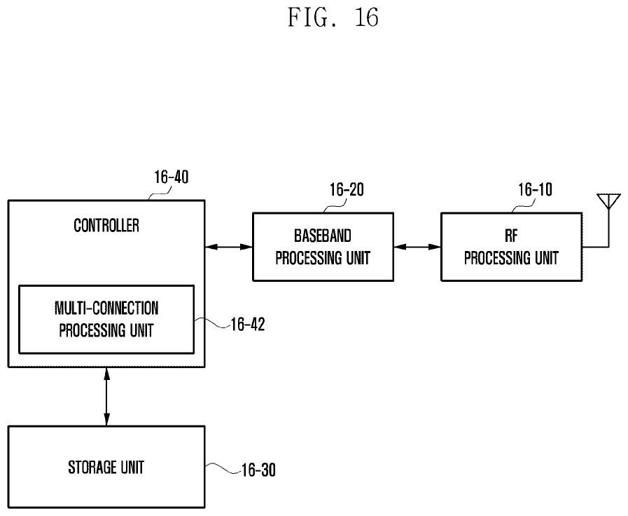

FIG. 16 is a diagram illustrating a configuration of a terminal according to an embodiment of the present disclosure.

Referring to FIG. 16, the terminal includes an RF (Radio Frequency) processing unit (16-10), a baseband processing unit (16-20), a storage unit (16-30), and a controller (16-40). The controller (16-40) may further include a multi-connection processing unit (16-42). The operation of the terminal described in FIG. 8 may be performed by the controller (16-40) The RF processing unit (16-10) performs functions for transmitting and receiving signals through a wireless channel, such as signal band conversion and amplification. That is, the RF processing unit (16-10) up-converts a baseband signal provided from the baseband processing unit (16-20) into an RF band signal and transmits it through an antenna, and down-converts an RF band signal received through the antenna into a baseband signal. For example, the RF processing unit (16-10) may include a transmission filter, a reception filter, an amplifier, a mixer, an oscillator, a digital to analog converter (DAC), an analog to digital converter (ADC), etc. Although in the drawing, only one antenna is shown, the terminal may be equipped with multiple antennas. In addition, the RF processing unit (16-10) may include multiple RF chains. Furthermore, the RF processing unit (16-10) may perform beamforming. For the beamforming, the RF processing unit (16-10) may adjust the phase and size of each signal transmitted and received through multiple antennas or antenna elements. In addition, the RF processing unit may perform MIMO and receive multiple layers when performing a MIMO operation.

The baseband processing unit (16-20) performs a conversion function between a baseband signal and a bit stream according to the physical layer specification of the system. For example, when transmitting data, the baseband processing unit (16-20) encodes and modulates a transmission bit stream to generate complex symbols. In addition, when receiving data, the baseband processing unit (16-20) restores a reception bit stream by demodulating and decoding a baseband signal provided from the RF processing unit (16-10). For example, in the case of orthogonal frequency division multiplexing (OFDM) method, when transmitting data, the baseband processing unit (16-20) encodes and modulates a transmission bit stream to generate complex symbols, maps the complex symbols to subcarriers, and then constructs OFDM symbols through an inverse fast Fourier transform (IFFT) operation and a cyclic prefix (CP) insertion. In addition, when receiving data, the baseband processing unit (16-20) divides the baseband signal provided from the RF processing unit (16-10) into OFDM symbol units, restores signals mapped to subcarriers through fast Fourier transform (FFT), and then restores the reception bit string through demodulation and decoding.

The baseband processing unit (16-20) and the RF processing unit (16-10) transmit and receive signals as described above. Accordingly, the baseband processing unit (16-20) and the RF processing unit (16-10) may be referred to as a transmitter, a receiver, a transceiver, or a communication unit. Furthermore, at least one of the baseband processing unit (16-20) and the RF processing unit (16-10) may include a plurality of communication modules to support a plurality of different wireless access technologies. In addition, at least one of the baseband processing unit (16-20) and the RF processing unit (16-10) may include different communication modules to process signals of different frequency bands. For example, the different wireless access technologies may include a wireless LAN (e.g., IEEE 802.11), a cellular network (e.g., LTE), etc. Additionally, the different frequency bands may include super high frequency (SHF) (e.g., 2.NRHz, NRhz) bands, millimeter wave (mm wave) (e.g., 60 GHz) bands.

The storage unit (16-30) stores data such as basic programs, application programs, and configuration information for the operation of the terminal. In particular, the storage unit (16-30) may store information related to a second access node that performs wireless communication using the second wireless access technology. In addition, the storage unit (16-30) provides stored data according to a request from the controller (16-40).

The controller (16-40) controls the overall operations of the terminal. For example, the controller (16-40) transmits and receives signals through the baseband processing unit (16-20) and the RF processing unit (16-10). In addition, the controller (16-40) records and reads data in the storage unit (16-30). For this purpose, the controller (16-40) may include at least one processor. For example, the controller (16-40) may include a communication processor (CP) that performs control for communication and an application processor (AP) that controls higher layers such as application programs.

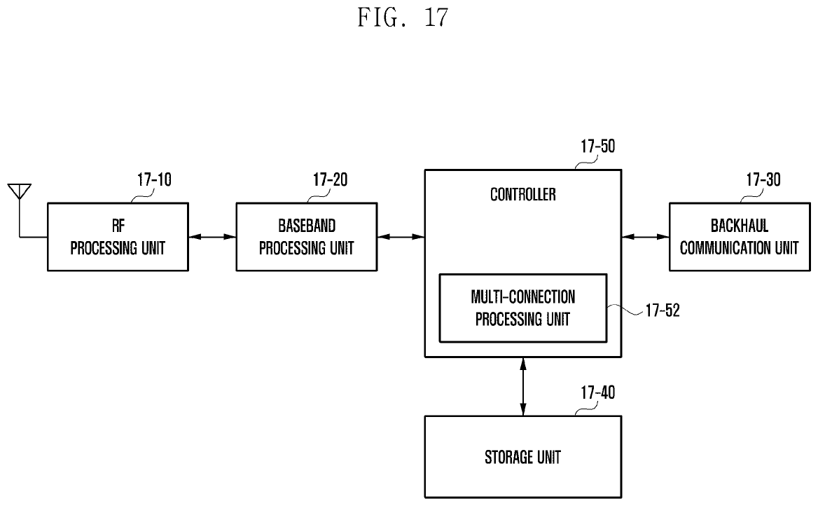

FIG. 17 is a diagram illustrating a configuration of a base station according to an embodiment of the present disclosure.

Referring to FIG. 17, the base station is configured to include an RF processing unit (17-10), a baseband processing unit (17-20), a backhaul communication unit (17-30), a storage unit (17-40), and a controller (17-50). The controller (17-50) may further include a multi-connection processing unit (17-52). The operation of the base station described in FIG. 11 may be performed by the controller (17-50).

The RF processing unit (17-10) performs functions for transmitting and receiving signals through a wireless channel, such as signal band conversion and amplification. That is, the RF processing unit (17-10) up-converts a baseband signal provided from the baseband processing unit (17-20) into an RF band signal and transmits it through an antenna, and down-converts an RF band signal received through the antenna into a baseband signal. For example, the RF processing unit (17-10) may include a transmission filter, a reception filter, an amplifier, a mixer, an oscillator, a DAC, an ADC, etc. Although in the drawing, only one antenna is shown, the first access node may be equipped with multiple antennas. In addition, the RF processing unit (17-10) may include multiple RF chains. Furthermore, the RF processing unit (17-10) may perform beamforming. For the beamforming, the RF processing unit (17-10) may adjust the phase and size of each signal transmitted and received through multiple antennas or antenna elements. The RF processing unit may perform a downward MIMO operation by transmitting one or more layers.

The baseband processing unit (17-20) performs a conversion function between a baseband signal and a bit stream according to the physical layer specifications of the first wireless access technology. For example, when transmitting data, the baseband processing unit (17-20) encodes and modulates a transmission bit stream to generate complex symbols. In addition, when receiving data, the baseband processing unit (17-20) restores a reception bit stream by demodulating and decoding a baseband signal provided from the RF processing unit (17-10). For example, in the case of OFDM, when transmitting data, the baseband processing unit (17-20) encodes and modulates a transmission bit stream to generate complex symbols, maps the complex symbols to subcarriers, and then constructs OFDM symbols through IFFT operation and CP insertion. In addition, when receiving data, the baseband processing unit (17-20) divides the baseband signal provided from the RF processing unit (17-10) into OFDM symbol units, restores the signals mapped to subcarriers through FFT operation, and then restores the reception bit string through demodulation and decoding. The baseband processing unit (17-20) and the RF processing unit (17-10) transmit and receive signals as described above. Accordingly, the baseband processing unit (17-20) and the RF processing unit (17-10) may be referred to as a transmitter, a receiver, a transceiver, a communication unit, or a wireless communication unit.

The backhaul communication unit (17-30) provides an interface for performing communication with other nodes within the network. That is, the backhaul communication unit (17-30) converts a bit string transmitted from the main base station to another node, such as an auxiliary base station or core network, into a physical signal, and converts a physical signal received from the other node into a bit string.

The storage unit (17-40) stores data such as basic programs, application programs, and configuration information for the operation of the base station. In particular, the storage unit (17-40) may store information on bearers allocated to the connected terminals, measurement results reported from connected terminals, and the like. In addition, the storage unit (17-40) may store information that serves as a determination criterion for whether to provide or terminate multiple connections to a terminal. In addition, the storage unit (17-40) provides the stored data according to a request from the controller (17-50).

The controller (17-50) controls the overall operations of the base station. For example, the controller (17-50) transmits and receives signals through the baseband processing unit (17-20) and the RF processing unit (17-10) or through the backhaul communication unit (17-30). In addition, the controller (17-50) records and reads data in the storage unit (17-40). For this purpose, the controller (17-50) may include at least one processor.

The methods according to the embodiments described in the claims or description of the present disclosure may be implemented in the form of hardware, software, or a combination of hardware and software.

In the case of software implementation, a computer-readable storage medium storing one or more programs (software modules) may be provided. The one or more programs stored in the computer-readable storage medium are configured for execution by one or more processors in an electronic device. The one or more programs include instructions that cause the electronic device to execute methods according to the embodiments described in the claims or description of the present disclosure.

These programs (software modules, software) may be stored in a random access memory, a non-volatile memory including a flash memory, a Read Only Memory (ROM), an Electrically Erasable Programmable Read Only Memory (EEPROM), a magnetic disc storage device, a Compact Disc-ROM (CD-ROM), a Digital Versatile Discs (DVDs) or other forms of optical storage devices, a magnetic cassette. Or, they may be stored in a memory configured by a combination of some or all of these. In addition, each configuration memory may be included in plurality.

Additionally, the program may be stored in an attachable storage device that is accessible via a communications network, such as the Internet, an Intranet, a Local Area Network (LAN), a Wide LAN (WLAN), or a Storage Area Network (SAN), or a combination thereof. The storage device may be connected to the device performing the embodiments of the present disclosure via an external port. Additionally, a separate storage device on the communications network may be connected to the device performing the embodiments of the present disclosure.

In the specific embodiments of the present disclosure described above, the components included in the present disclosure are expressed in the singular or plural form according to the specific embodiments presented. However, the singular or plural expressions are selected to suit the presented situation for the convenience of explanation, and the present disclosure is not limited to the singular or plural components, and even if a component is expressed in the plural form, it may be of the singular form, or even if a component is expressed in the singular form, it may be of the plural form.

Meanwhile, the embodiments of the present disclosure disclosed in this description and drawings are only specific examples to easily explain the technical content of the present disclosure and help understand the present disclosure, and they are not intended to limit the scope of the present disclosure. That is, it is obvious to a person having ordinary skill in the art to which the present disclosure pertains that other modified examples based on the technical idea of the present disclosure are possible. In addition, each of the above embodiments may be combined and operated with each other as needed. For example, parts of one embodiment of the present disclosure and another embodiment may be combined with each other to operate a base station and a terminal. In addition, the embodiments of the present disclosure may be applied to other communication systems, and other modified examples based on the technical idea of the embodiments may also be implemented.

1. A method for a terminal in a wireless communication system, the method comprising:
receiving, from a base station, control information for reporting a buffer status report (BSR);
acquiring first buffer size information and second buffer size information for a logical channel group (LCG) based on the control information; and
transmitting, to the base station, a medium access control control element (MAC CE) including the first buffer size information and the second buffer size information for the LCG,
wherein the second buffer size information is determined based on a buffer size of the LCG and a buffer size of the first buffer size information.

2. The method of claim 1,
wherein the delta buffer size information corresponds to a delta buffer size determined based on a difference between the buffer size of the first buffer size information and the buffer size of the LCG, and
wherein the MAC CE further includes an identity of the LCG.

3. The method of claim 1, further comprising:
transmitting, to the base station, capability information of the terminal, the capability information including a parameter indicating that a usage of the second buffer size information is supported by the terminal.

4. The method of claim 1,
wherein the control information further includes a list of LCGs for the second buffer size information and a threshold, and
wherein the second buffer size information is acquired for the MAC CE, in case that the buffer size of the LCG is larger than the threshold.

5. A method for a base station in a wireless communication system, the method comprising:
transmitting, to a terminal, control information for reporting a buffer status report (BSR);
receiving, from the terminal, a medium access control control element (MAC CE) including first buffer size information and second buffer size information for a logical channel group (LCG) based on the control information; and
determining a buffer size of the LCG based on the first buffer size information and the second buffer size information,
wherein the second buffer size information is determined based on a buffer size of a the LCG and a buffer size of the first buffer size information.

6. The method of claim 5,
wherein the delta buffer size information corresponds to a delta buffer size determined based on a difference between the buffer size of the first buffer size information and the buffer size of the LCG, and
wherein the MAC CE further includes an identity of the LCG.

7. The method of claim 5, further comprising:
receiving, from the terminal, capability information of the terminal, the capability information including a parameter indicating that a usage of the second buffer size information is supported by the terminal.

8. The method of claim 5,
wherein the control information further includes a list of LCGs for the second buffer size information and a threshold, and
wherein the second buffer size information is acquired for the MAC CE, in case that the buffer size of the LCG is larger than the threshold.

9. A terminal in a wireless communication system, the terminal comprising:
a transceiver; and
at least one processor coupled to the transceiver and configured to:
receive, from a base station, control information for reporting a buffer status report (BSR);
acquire first buffer size information and second buffer size information for a logical channel group (LCG) based on the control information; and
transmit, to the base station, a medium access control control element (MAC CE) including the first buffer size information and the second buffer size information for the LCG,
wherein the second buffer size information is determined based on a buffer size of a the LCG and a buffer size of the first buffer size information.

10. The terminal of claim 9,
wherein the delta buffer size information corresponds to a delta buffer size determined based on a difference between the buffer size of the first buffer size information and the buffer size of the LCG, and
wherein the MAC CE further includes an identity of the LCG.

11. The terminal of claim 9,
wherein the at least one processor is configured to transmit, to the base station, capability information of the terminal, the capability information including a parameter indicating that a usage of the second buffer size information is supported by the terminal.

12. The terminal of claim 9,
wherein the MAC CE control information further includes a list of LCGs for the second buffer size information and a threshold, and
wherein the second buffer size information is acquired for the MAC CE, in case that the buffer size of the LCG is larger than the threshold.

13. A base station in a wireless communication system, the base station comprising:
a transceiver; and
at least one processor coupled to the transceiver and configured to:
transmit, to a terminal, control information for reporting a buffer status report (BSR);
receive, from the terminal, a medium access control control element (MAC CE) including first buffer size information and second buffer size information for a logical channel group (LCG) based on the control information; and
determine a buffer size of the LCG based on the first buffer size information and the second buffer size information,
wherein the second buffer size information is determined based on a buffer size of the LCG and a buffer size of the first buffer size information.

14. The base station of claim 13,
wherein the delta buffer size information corresponds to a delta buffer size determined based on a difference between the buffer size of the first buffer size information and the buffer size of the LCG, and
wherein the MAC CE further includes an identity of the LCG.

15. The base station of claim 13,
wherein the at least one processor is configured to receive, from the terminal, capability information of the terminal, the capability information including a parameter indicating that a usage of the second buffer size information is supported by the terminal.

16. The base station of claim 13,
wherein the control information further includes a list of LCGs for the second buffer size information and a threshold, and
wherein the second buffer size information is acquired for the MAC CE, in case that the buffer size of the LCG is larger than the threshold.
